(19) United States
(12) Patent Application Publication
(10) Pub. No.: US 2004/0030040 A1
(43) Pub. Date: Feb. 12, 2004

(54) Method of producing aqueous copolymer dispersions from copolymers that comprise carbon monoxide and at least one olefinically unsaturated compound

(76) Inventors: Markus Schmid, Deidesheim (DE); Ekkehard Lindner, Tubingen (DE); Joachim Wald, Albstadt-Ebingen (DE); Monika Forster, Kusterdingen (DE); Peter Wegner, Tubingen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,249

(22) PCT Filed: Dec. 11, 2001
(86) PCT No.: PCT/EP01/14530

(30) Foreign Application Priority Data
Dec. 12, 2000 (DE) 10061877.4

(51) Int. Cl. C08L 1/00

(52) U.S. Cl. 524/801

(57) ABSTRACT

The invention relates to a method of producing aqueous copolymer dispersions from copolymers that comprise carbon monoxide and at least one olefinically unsaturated compound.

The present invention relates to a process for the preparation of aqueous copolymer dispersions of copolymers of carbon monoxide and at least one olefinically unsaturated compound.

Copolymers of carbon monoxide and olefinically unsaturated compounds, also referred to as carbon monoxide copolymers or polyketones for short, are known. For example, high molecular weight semicrystalline polyketones having a strictly alternating sequence for the monomers in the main chain generally have high melting points, good heat distortion resistance, good resistance to chemicals, good barrier properties with respect to water and air and advantageous mechanical and rheological properties.

Polyketones obtained from carbon monoxide and olefins, in general α-olefins, for example carbon monoxide/ethene, carbon monoxide/propene, carbon monoxide/ethene/propene, carbon monoxide/ethene/1-butene, carbon monoxide/ethene/1-hexene, carbon monoxide/propene/1-butene and carbon monoxide/propene/1-hexene copolymers, are of industrial interest.

Transition metal-catalyzed processes for the preparation of polyketones are known. For example a cis-palladium complex, [Pd(Ph₂P(CH₂)₃PPh₂)](OAc)₂ (Ph=phenyl, Ac=acetyl), chelated with bidentate phosphine ligands is used in EP-A 0 121 965. The carbon monoxide copolymerization can be carried out in suspension, as described in EP-A 0 305 011, or in the gas phase, for example according to EP-A 0 702 045. Frequently used suspending media are on the one hand low molecular weight alcohols, in particular methanol (cf. also EP-A 0 428 228) and on the other hand nonpolar or polar aprotic liquids, such as dichloromethane, toluene or tetrahydrofuran (cf. EP-A 0 460 743 and EP-A 0 590 942). Complexes with bisphosphine chelate ligands whose radicals on the phosphorus are aryl or substituted-aryl groups have proven particularly suitable for said copolymerization processes. Accordingly, 1,3-bis(diphenylphosphine)propane and 1,3-bis[di(o-methoxyphenyl)phosphino]propane are particularly frequently used as chelate ligands (cf. also Drent et al., Chem. Rev., 96, 1996, 663 to 681). In said cases, the carbon monoxide copolymerization is usually carried out in the presence of acids. *The carbon monoxide copolymerization in low molecular weight alcohols, such as methanol, has the disadvantage that the carbon monoxide copolymer which forms has a high absorptivity of these liquids and up to 80% by volume of, for example, methanol are bound or taken up by the carbon monoxide copolymer. Accordingly, a high energy consumption is required in order to dry the carbon monoxide copolymers and to isolate them in pure form. Another disadvantage is that, even after an intensive drying process, residual amounts of alcohol still remain in the carbon monoxide copolymer. Use as packaging material for food is therefore not possible from the outset for molding materials produced in this manner. EP-A 0 485 035 proposes the addition of from 2.5 to 15% by weight of water to the alcoholic suspending medium in order to eliminate the residual amounts of low molecular weight alcohol in the carbon monoxide copolymer. However, this procedure too does not lead to methanol-free copolymers. On the other hand, the use of halogenated hydrocarbons or aromatics, such as dichloromethane or chlorobenzene or toluene, gives rise to problems, in particular in the handling and disposal.

In order to avoid the disadvantages associated with said suspending media, Jiang and Sen, Macromolecules, 27, 1994, 7215 to 7216, describe the preparation of carbon monoxide copolymers in aqueous systems using a catalyst system consisting of [Pd(CH₃CN)₄](BF₄)₂ and 1,3-bis[di(3-sulfophenyl)phosphino]propane as water-soluble chelate ligands. However, the catalyst activity achieved is unsatisfactory.

Compared with Jiang and Sen, Verspui et al., Chem. Commun., (1998), 401 to 402, succeed in increasing the catalyst activity in the copolymerization of carbon monoxide and ethene by using said chelate ligands in substantially purer form. Furthermore, the presence of a Brönsted acid is required in order to obtain catalyst activities improved compared with Jiang and Sen. The polyketones described in the publication prepared from carbon monoxide and ethylene have the disadvantage that their molecular weight is below that of polyketones which are comparable but prepared in methanol as a solvent.

The application filed by the Applicant at the German Patent and Trademark Office under the application number 19917920.4 relates to a process for the metal-catalyzed preparation of linear, alternating copolymers of carbon monoxide and an olefinically unsaturated compound having three to twenty carbon atoms in an aqueous medium.

What is of importance is that all processes mentioned in the above prior art are tailored for the formation of copolymer agglomerates whose mean particle size is as a rule >>2 μm, which can be separated from the liquid medium in a simple manner, for example by filtration. As a result of the specific design of the processes, it is intended in particular to avoid the formation of stable copolymer dispersions whose mean particle size is as a rule ≦2 μm.

In contrast, it is an object of the present invention to provide a process for the preparation of aqueous copolymer dispersions of copolymers of carbon monoxide and at least one olefinically unsaturated compound.

We have found that this object is achieved by a process for the preparation of aqueous copolymer dispersions of copolymers of carbon monoxide and at least one olefinically unsaturated compound, wherein the copolymerization of carbon monoxide and at least one olefinically unsaturated compound is carried out in an aqueous medium in the presence of

a1) metal complexes of the formula (I)

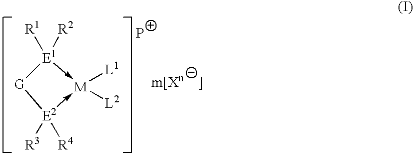

wherein

G is a 5-, 6- or 7-atom carbocyclic ring system with or without one or more heteroatoms, —(CR^{b}₂)ᵣ—, —(CR^{b}₂)ₛ—Si(R^{a})₂—(CR^{b}₂)ₜ—, -A-O—B— or -A-Z(R⁵)—B—,

R⁵ is hydrogen, or is C₁- to C₂₀-alkyl, C₃- to C₁₄-cycloalkyl, C₆- to C₁₄-aryl or alkylaryl having 1 to 20 carbon atoms in the alkyl radical and 6 to 14 carbon atoms in the aryl radical, which are unsubstituted or substituted by functional groups which contain atoms of groups IVA, VA, VIA or VIIA of the Periodic Table of the Elements, —N(R^{b})₂, —Si(R^{c})₃ or a radical of the formula (II)

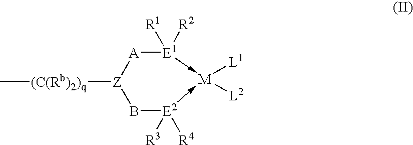

where

q is an integer from 0 to 20 and the further substituents in formula (II) have the same meanings as those in formula (I),

A, B are each —(CR^{b}₂)_{r′}—, —(CR^{b}₂)ₛ—Si(R^{a})₂—(CRb²)ₜ—, —N(R^{b})—, an r′-, s- or t-atom component of a ring system or, together with Z, an (r′+1)-, (s+1)- or (t+1)-atom component of a heterocyclic structure,

R^{a} independently of one another, are linear or branched C₁- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, it also being possible for said radicals to be substituted,

R^{b} has the same meanings as R^{a}, and may additionally be hydrogen or —Si(R^{c})₃,

R^{c} independently of one another, are linear or branched C₁- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, it also being possible for said radicals to be substituted,

r is 1, 2, 3 or 4 and

r′ is 1 or 2,

s, t are each 0, 1 or 2, where 1≦s+t≦3,

z is a nonmetallic element from group VA of the Periodic Table of the Elements,

M is a metal selected from the groups VIIIB, IB or IIB of the Periodic Table of the Elements,

E¹, E² are each a nonmetallic element from group VA of the Periodic Table of the Elements,

R¹ to R⁴ independently of one another, are each linear or branched C₂- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, at least one of the radicals R¹ to R⁴ having at least one hydroxyl, amino or acid group or containing an ionic functional group,

L¹, L² are formally charged or neutral ligands,

x are formally monovalent or polyvalent anions,

p is 0, 1, 2, 3 or 4,

m, n are each 0, 1, 2, 3 or 4,

where p is m×n,

b) a dispersant and, if required,

c) a hydroxy compound

and a compound containing the structural element of the formula (III)

—CH═CH-Q-Polₓ (III),

or a mixture of a compound containing the structural element of the formula (III) and an olefinically unsaturated compound of 2 to 20 carbon atoms is used as at least one olefinically unsaturated compound,

where

Q is a nonpolar organic group selected from the group consisting of linear or branched C₁- to C₂₀-alkyl, C₃- to C₁₄-cycloalkyl, C₆- to C₁₄-aryl, alkylaryl having 1 to 20 carbon atoms in the alkyl moiety and 6 to 14 carbon atoms in the aryl moiety and

π is an integer not equal to 0, and is preferably 1, 2, 3 or 4, and

Pol is a polar radical selected from the group consisting of

carboxyl, sulfonyl, sulfate, phosphonyl, phosphate and the alkali metal, alkaline earth metal and/or ammonium salts thereof,

alkanolammonium, pyridinium, imidazolinium, oxazolinium, morpholinium, thiazolinium, quinolinium, isoquinolinium, tropylium, sulfonium, guanidinium and phosphonium compounds and ammonium compounds of the formula (IV)

—N^{⊕}R⁶R⁷R⁸ (IV),

where

R⁶, R⁷ and R⁸, independently of one another, are each hydrogen or linear or branched C₁- to C₂₀-alkyl, or

a group of the formula (V), (VI) or (VII)

-(EO)ₖ—(PO)ₗ—R⁹ (V),

—(PO)ₗ-(EO)ₖ—R⁹ (VI),

-(EOₖ/POₗ)—R⁹ (VII),

where

EO is a —CH₂—CH₂—O— group,

PO is a —CH₂—CH(CH₃)—O— or a —CH(CH₃)—CH₂—O—group,

k and l are each from 0 to 50, but k and l are not simultaneously 0, and

R⁹ is hydrogen, linear or branched C₁- to C₂₀-alkyl or —SO₃H or the corresponding alkali metal, alkaline earth metal and/or ammonium salts thereof.

The present invention also relates to a process in which the metal complex a1) is not initially taken in the form of a defined compound but is formed in situ from the initial components before and/or during the copolymerization.

The present invention furthermore relates to a process for the preparation of aqueous copolymer dispersions of copolymers of carbon monoxide and at least one olefinically unsaturated compound, in which an acid and, if required, hydroxy compound are used in addition to said components a1) and b) or a1.1), a1.2) and b).

The present invention also relates to the aqueous copolymer dispersions prepared by the process and to the use thereof and to the copolymer powders obtainable from the aqueous copolymer dispersions and to the use thereof.

The designations for the groups of the Periodic Table of the Elements are based on the nomenclature used by Chemical Abstracts Service up to 1986 (for example, group VA contains the elements N, P, As, Sb and Bi; group IB contains Cu, Ag and Au).

In a preferred process according to the invention, the copolymerization is carried out in the presence of

a1) a water-soluble metal complex of the formula (Ia)

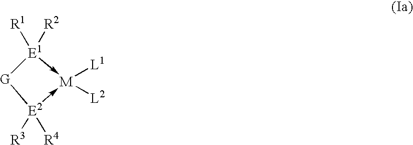

where

G is —(CR^{b}₂)ᵣ— or —(CR^{b}₂)—N(R⁵)—(CR^{b}₂)—,

R^{b} is hydrogen, C₁- to C₁₀-alkyl or C₆- to C₁₀-aryl,

r is 1, 2, 3 or 4,

R⁵ is hydrogen, linear or branched C₁- to C₁₀-alkyl, C₃- to C₁₀-cycloalkyl, or C₆- to C₁₄-aryl, having functional groups which contain atoms of groups IVA, VA, VIA or VIIA of the Periodic Table of the Elements,

M is palladium or nickel,

E¹ and E² are each phosphorus,

R¹ to R⁴ are each linear, branched or carbocycle-containing C₂- to C₂₀-alkyl units, C₃- to C₁₄-cycloalkyl units, C₆- to C₁₄-aryl units or alkylaryl groups having 1 to 20 carbon atoms in the alkyl moiety and 6 to 14 carbon atoms in the aryl moiety, at least one of the radicals R¹ to R⁴ having at least one terminal or internal hydroxyl, amino, carboxyl, phosphoric acid, ammonium or sulfo group or at least one of said groups present as substituent,

L¹ and L² are each acetate, trifluoroacetate, tosylate or halide,

a2) sulfuric acid, p-toluenesulfonic acid, tetrafluoroboric acid, trifluoromethanesulfonic acid, perchloric acid or trifluoroacetic acid as a protic acid or boron trifluoride, antimony pentafluoride or a triarylborane as Lewis acid,

b) an anionic, cationic and/or nonionic emulsifier and

c) a monohydric or polyhydric alcohol and/or a sugar.

In a further embodiment, a process is preferred in which the metal complex a1) has, among R¹ to R⁴, at least one radical which is C₂- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, which are substituted by at least one free carboxyl or sulfo group, the presence of external acids a2) being completely dispensed with.

In a further novel process, the metal complex a1) is not prepared beforehand and used in defined form in the copolymerization but is only produced in situ by adding the metal component a1.1) and the chelate ligand a1.2) to the starting materials of the copolymerization.

In principle, bidentate chelate ligands of the formula (R¹)(R²)E¹-G-E²(R³)(R⁴) (VIII), in which the substituents and indices have the above meanings, are suitable as a component of the metal complexes a1) or as chelate ligand a1.2) in the novel process.

The bridging structural unit G in the metal complexes a1) or in the chelate ligands a1.2) of the novel process generally consists of monoatomic or polyatomic bridge segments. A bridging structural unit is understood in principle as meaning a group which links the elements E¹ and E² to one another. Such structural units include, for example, substituted or unsubstituted alkylene chains or those alkylene chains in which an alkylene unit is replaced by a silylene group, an amino or phosphino group or an ether oxygen.

The bridging structural unit G may furthermore be a 5-, 6- or 7-atom carbocyclic ring system with or without one or more heteroatoms. The ring system may be aliphatic or aromatic. 5- or 6-atom ring systems having 0, 1 or 2 heteroatoms, selected from N, O and S, are preferred.

The bonds to the atoms E¹ and E² may assume any desired position relative to one another. Preferred positions relative to one another are the 1,2-, 1,3- and 1,4-positions.

Preferred embodiments for cyclic structural units G are the following (bonding sites to E¹ and E² are indicated):

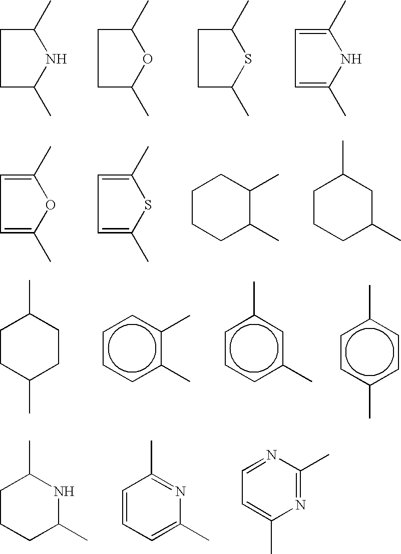

Among the monoatomically bridged structural units, those having a bridging atom from group IVA of the Periodic Table of the Elements, such as —C(R^{b})₂— or —Si(R^{a})₂—, where R^{a} independently of one another are each in particular linear or branched C₁- to C₁₀-alkyl, for example methyl, ethyl, isopropyl or tert-butyl, C₃-to C₆-cycloalkyl, such as cyclopropyl or cyclohexyl, C₆- to C₁₀-aryl, such as phenyl or naphthyl, C₆- to C₁₀-aryl substituted by functional groups which contain nonmetallic elements of groups IVA, VA, VIA or VIIA of the Periodic Table of the Elements, for example tolyl, (trifluoromethyl)phenyl, dimethylaminophenyl, p-methoxyphenyl or partially halogenated or perhalogenated phenyl, aralkyl having 1 to 6 carbon atoms in the alkyl moiety and 6 to 10 carbon atoms in the alkyl moiety, for example benzyl, and Rb are each in particular hydrogen and may furthermore have the meanings stated above for R^{a} are preferred. R^{a} is in particular methyl and R^{b} is in particular hydrogen.

Among the polyatomically bridged systems, the diatomically, triatomically and tetraatomically bridged structural units are noteworthy, the triatomically bridged systems generally being preferably used.

Suitable triatomically bridged structural units are based in general on a chain of carbon atoms, for example propylene (—CH₂CH₂CH₂—), or on a bridge unit having a heteroatom from group IVA, VA or VIA of the Periodic Table of the Elements, such as silicon, nitrogen, phosphorus or oxygen, in the chain skeleton.

The bridge carbon atoms may be substituted in general by C₁- to C₆-alkyl, such as methyl, ethyl or tert-butyl, or C₆- to C₁₀-aryl, such as phenyl, or by functional groups which contain elements of groups IVA, VA, VIA or VIIA of the Periodic Table of the Elements, for example triorganosilyl, dialkylamino, alkoxy, hydroxyl or halogen. Suitable substituted propylene bridges are, for example, those having a methyl, phenyl, hydroxyl, trifluoromethyl, ω-hydroxyalkyl or methoxy group in 2-position.

Advantageously used polyatomically bridged structural units having a heteroatom in the chain skeleton are compounds in which z is nitrogen or phosphorus, in particular nitrogen (also see formula (I)). R⁵ on Z may be in particular hydrogen, linear or branched C₁- to C₂₀-alkyl, in particular C₁- to C₁₈-alkyl, such as methyl, ethyl, isopropyl, tert-butyl, n-hexyl or n-dodecyl, C₃- to C₁₄-cycloalkyl, in particular C₃- to C₈-cycloalkyl, such as cyclopropyl or cyclohexyl, C₆- to C₁₄-aryl, in particular C₆- to C₁₀-aryl, for example phenyl, or alkylaryl having 1 to 20 carbon atoms in the alkyl radical and 6 to 10 carbon atoms in the aryl radical, for example benzyl.

Said alkyl and aryl radicals may be unsubstituted or substituted. Examples of suitable substituents are functional groups which contain atoms of groups IVA, VA, VIA or VIIA of the Periodic Table of the Elements. Inter alia, triorganosilyl groups, such as trimethylsilyl or tert-butyldiphenylsilyl, the carboxyl group of carboxylic acid derivatives, such as esters or amides, primary, secondary or tertiary amino groups, such as dimethylamino or methylphenylamino, the nitro and the hydroxyl group, furthermore alkoxy radicals, such as methoxy or ethoxy, the sulfonate group and halogen atoms, such as fluorine, chlorine or bromine, are suitable. In the context of the present invention, aryl is also substituted or unsubstituted heteroaryl, for example pyridyl or pyrrolyl. Alkyl radicals R⁵ also include long-chain alkylene groups having 12 to 20 carbon atoms in the chain, which may also have functionalities such as the sulfo, carboxyl, phosphoric acid, hydroxyl, amino or ammonium group, for example in a terminal position, and radicals of the formula (IX)

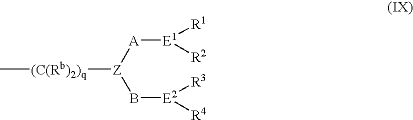

where q is an integer from 0 to 20 and the further substituents in formula (IX) have the same meanings as in formula (II).

Those compounds which constitute an electron-attracting substituent are also preferred as radicals R⁵. Suitable electron-attracting substituents are, for example, alkyl having one or more electron-attracting radicals, such as fluorine, chlorine, nitrile or nitro, in the α- or β-position relative to Z. Also suitable are aryl having said electron-attracting radicals and also radicals bonded directly to Z, including the nitrile, sulfonate and nitro group. Examples of suitable electron-attracting alkyl radicals are trifluoromethyl, trichloroethyl, difluoromethyl, 2,2,2-trifluoroethyl, nitromethyl and cyanomethyl. Examples of suitable electron-attracting aryl radicals are m-, p-, o-fluoro and chlorophenyl, 2,4-difluorophenyl, 2,4-dichlorophenyl, 2,4,6-trifluorophenyl, 3,5-bis(trifluoromethyl)phenyl, nitrophenyl, 2-chloro-5-nitrophenyl and 2-bromo-5-nitrophenyl. In this context, carbonyl units are likewise suitable as radicals R⁵, so that, if Z is nitrogen, Z and R⁵ form a carboxamido functionality. Examples of suitable radicals of this type are acetyl and trifluoroacetyl.

The radicals R⁵ are preferably tert-butyl, phenyl, p-fluorophenyl, trifluoromethyl, 2,2,2-trifluoroethyl, pentafluorophenyl, 3,5-bis(trifluoromethyl)phenyl and ortho, e.g. 3,4-, meta-, e.g. 2,4-, and para-, e.g. 2,5-difluorophenyl.

Suitable units A and B according to the formulae (II) and (IX) are C₁- to C₄-alkylene units in substituted or unsubstituted form, for example methylene, ethylene, propylene or ethylidene, propylidene and benzylidene. Methylene, ethylene, ethylidene or benzylidene is preferably used, particularly preferably methylene.

A and B may also be a monoatomic, diatomic or tetraatomic component of an aliphatic or aromatic ring system. For example, A and B may be a methylene or ethylene unit of a cyclopropyl, cyclopentyl or cyclohexyl ring. Other suitable ring systems are aliphatic and aromatic heterocycles.

A and B may furthermore be constituents of a heterocyclic structure which is formed from the components A-Z(R⁵)—B, A-Z-R⁵ or B-Z-R⁵. A-Z-R⁵ and B-Z-R⁵ may form, for example, a substituted or unsubstituted pyrrolidine or piperidine ring.

Suitable chelating atoms E¹ and E² are, independently of one another, nonmetallic elements of group VA of the Periodic Table of the Elements, nitrogen and phosphorus preferably being employed, in particular phosphorus. In a preferred embodiment, E¹ and E² in the compounds according to the formulae (I), (II), (VIII) and (IX) are each phosphorus.

In the novel process, R¹ to R⁴ are each substituted C₂- to C₂₀-alkyl, preferably C₃- to C₁₈-alkyl, C₃- to C₁₄-cycloalkyl, preferably C₃- to C₈-cycloalkyl, C₆- to C₁₄-aryl, preferably C₆- to C₁₀-aryl or alkylaryl having 1 to 20, preferably 3 to 18 carbon atoms in the alkyl moiety and 6 to 14, preferably 6 to 10 carbon atoms in the aryl moiety, at least one, preferably a plurality, particularly preferably all, of the radicals R¹ to R⁴ having at least one hydroxyl, amino or acid group or containing an ionic functional group. Ionic functional groups are groups based on nonmetallic elements of groups IVA to VIA of the Periodic Table of the Elements, e.g. sulfonate, phosphate, ammonium or carboxylate. R¹ to R⁴ are each preferably linear, branched or carbocycle-containing C₂- to C₂₀-alkyl units or C₃- to C₁₄-cycloalkyl units, or C₆- to C₁₄-aryl units or alkylaryl groups having 1 to 20 carbon atoms in the alkyl moiety and 6 to 14 carbon atoms in the aryl moiety, at least one, preferably a plurality, particularly preferably all, of the radicals containing at least one hydroxyl, carboxyl, phosphoric acid, ammonium, amino or sulfo group.

The salts of the carboxylic, phosphoric or sulfonic acids may also be used. Suitable salts are, for example, ammonium, alkylammonium, arylammonium, alkali metal or alkaline earth metal salts, such as sodium, potassium or magnesium carboxylates or sulfonates.

Particularly suitable opposite ions for said ammonium radicals are non-nucleophilic anions, as also used for the metal complexes a1) (cf. anions X). For example, sulfate, nitrate, acetate, p-toluenesulfonate, tetrafluoroborate, trifluoroacetate, trichloroacetate, hexafluorophosphate, hexafluoroantimonate and tetraarylborates are particularly suitable.

Particularly suitable aryl radicals R¹ to R⁴ are, for example, aryl units with or without one or more, for example from 1 to 3, heteroatoms in the ring, which are substituted by one or two hydroxyl, carboxyl, sulfo or amino groups. Among the aryl or arylene radicals R¹ to R⁴, the phenyl(ene) radical is preferred. R¹ to R⁴ may also have more than two polar groups and may have, for example, four or six hydroxyl, ammonium or carboxyl groups. Preferred cycloaliphatic radicals R¹ to R⁴ are cyclopentyl and cyclohexyl. Particularly suitable alkyl radicals R¹ to R⁴ are also, for example, alkylene units having one or more terminal hydroxyl, carboxyl, sulfo or ammonium groups. In these cases, too, R¹ to R⁴ may have more than two polar groups and may have, for example, four or six hydroxyl, ammonium or carboxyl groups. Accordingly, R¹ to R⁴ may each also have different functional groups. R¹ to R⁴ may also have functional groups in numbers differing from one another. Examples of suitable functional groups are the hydroxyl, amino, carboxyl, phosphoric acid, ammonium and sulfo groups.

The preparation of suitable propylene-bridged chelate ligand compounds can be carried out, for example, starting from the commercially available 1,3-dibromopropane. A double Arbuzov reaction, for example with triethyl phosphite, gives 1,3-bisphosphonic acid derivatives, which can be converted by reduction, as described in “Methoden der organischen Chemie (Houben-Weyl)”, 4^{th} edition, volume XII/1, part 1, Georg Thieme Verlag, 1963, p. 62, into 1,3-diphosphinopropane. 1,3-Diphosphinopropane offers a flexible route to substituted bisphosphines via a hydrophosphination reaction with functionalized olefins. The hydrophosphination takes place in general via a free radical mechanism and can be initiated thermally, photochemically or with the aid of a free radical initiator. For a thermal initiation, in general temperatures of from 20 to 100° C. and pressures from 0.1 to 5 bar are required. Examples of suitable free radical initiators are di-tert-butyl peroxide and azobisisobutyronitrile. For the photochemical initiation, exposure to UV light from a high-pressure mercury lamp over a period of from 2 to 48 hours is as a rule sufficient for quantitative hydrophosphination. Free radical hydrophosphination generally gives Anti-Markovnikov products.

For the preparation of chelate ligands having radicals R¹ to R⁴ which carry carboxyl groups, it has proven advantageous to start from olefinically unsaturated compounds which are derivatized with corresponding carboxylic ester groups and to use them in the hydrophosphination reaction. The free carboxylic acids can then be obtained by hydrolysis by known methods.

Suitable chelate ligand compounds can also be prepared under conditions of acid catalysis. The products obtained by this process frequently occur as a mixture, owing to the isomerization of the olefinic double bond under the acidic reaction conditions. The hydrophosphination step of the process is described, for example, in “Methoden der organischen Chemie (Houben-Weyl)”, 4th edition, volume XII/1, part 1, Georg Thieme Verlag, 1963, pages 25 to 28.

In general, all olefins belonging to this class of compounds are suitable for said hydrophosphination reaction, provided that they have corresponding functional groups, for example hydroxyl, amino, carboxyl, phosphoric acid, ammonium and sulfo groups. For example, propenyl radicals and C₄- to C₂₀-alkenes having at least one internal or terminal double bond, which have at least one hydroxyl, amino, carboxyl, phosphoric acid, ammonium or sulfo group, are suitable. Olefinic compounds having aromatic radicals are also suitable, it being possible for the functional group to be either on the aliphatic or the aromatic radical, for example 4-(1-pentenyl)benzoic acid or 3-phenylpent-5-enecarboxylic acid. Furthermore, olefinic compounds having aliphatic carbocycles in the alkylene chain as substituents are suitable. Cyclic olefins, such as cyclohexen-3-ol or cycloocten-4-ol, can also be used. It is of course also possible to employ olefins having a plurality of functional groups selected from hydroxyl, amino, carboxyl, phosphoric acid, ammonium and sulfo groups. Preferably, suitable alkenes having an a-olefinic double bond are used in the hydrophosphination reaction of the α,ω-bisphosphines. Examples of suitable alkenes of this type include heteroatom-containing α-olefins, such as (meth)acrylates and (meth)acrylamides and homoallyl and allyl alcohols.

In the case of aromatic radicals R¹ to R⁴ chelate ligands which contain sulfo groups can be prepared by reacting chelate ligands which do not contain sulfo groups with sulfur trioxide, chlorosulfonic acid, fuming sulfuric acid or oleum, as described in Jiang et al., Macromolecules 27 (1994) 7215 to 7216, or Verspui et al., Chem. Commun., (1998), 401 to 402, or in J. March “Advanced Organic Chemistry”, John Wiley & Sons (NY), 1985, 3^{rd} Edition, pages 473 to 475.

Further syntheses for chelate ligands having aromatic radicals R¹ to R⁴ are described in:

“Phosphorus—An outline of its Chemistry, Biochemistry and Technical Chemistry” D.E.C. Corbridge, Elsevier (Amsterdam, Tokyo, New York) 1990, 4th Edition, Chapter 8, and literature cited therein

S. O. Grim, R. C. Barth, J. of Organomet. Chem. 94, 1975, 327

WO98/22482

Radicals R¹ to R⁴ in which the hydrophilic character induced by functional groups, for example, hydroxyl, amino, carboxyl, phosphoric acid, ammonium or sulfo groups, is sufficient to render the metal complex a1) completely water-soluble are particularly preferably employed. The larger the number of functional groups on R¹ to R⁴, the greater may be the lipophilic aliphatic, aromatic or aliphatic-aromatic proportion. Preferred radicals R¹ and R⁴ having a hydroxyl group in each case, for example, are those having 2 to 15 carbon atoms in the alkyl unit or 6 to 14 carbon atoms in the aryl unit.

In a particularly preferred embodiment of the chelate ligand, aryl substituents R¹ to R⁴ having a hydroxyl group are of 6 to 14, in particular 6 to 10 carbon atoms, aryl substituents R¹ to R⁴ having a carboxyl group are of 6 to 14, in particular 6 to 10, carbon atoms, aryl substituents R¹ to R⁴ having a sulfo group are of 6 to 14 carbon atoms and aryl substituents R¹ to R⁴ having an ammonium group are of 6 to 14 carbon atoms.

Examples of suitable chelate ligands are

1,3-bis[di(hydroxyphenyl)phosphino]propane,

1,3-bis[di(sulfophenyl)phosphino]propane, preferably as the metaisomer, and its salts,

1,3-bis[di(carboxyphenyl)phosphino)propane and its salts,

1,3-bis[di(o-methoxyhydroxyphenyl)phosphino]propane

1,3-bis[di(4-(sulfophenyl)butyl)phosphino]propane, sodium salt, and

1,3-bis[di(5-(sulfophenyl)pentyl)phosphino]propane, sodium salt.

Particularly preferred among said chelate ligand compounds are those in which R¹ to R⁴ are each phenyl substituted by one or more, for example 1 to 3, hydroxyl, sulfo or carboxyl groups.

In a particularly preferred embodiment of the chelate ligand, alkyl substituents R¹ to R⁴ having a hydroxyl group are of 4 to 12, in particular 4 to 7, carbon atoms, alkyl substituents R¹ to R⁴ having a carboxyl group are of 4 to 15, in particular 5 to 12, carbon atoms, alkyl substituents R¹ to R⁴ having a sulfo group are of 4 to 18, in particular 5 to 15, carbon atoms and alkyl substituents R¹ to R⁴ having an ammonium group are of 4 to 20, in particular 5 to 18, carbon atoms.

Examples of suitable chelate ligands are

1,3-bis[di(4-hydroxybutyl)phosphino]propane,

1,3-bis[di(5-hydroxypentyl)phosphino]propane,

1,3-bis[di(6-hydroxyhexyl)phosphino]propane,

1,3-bis[di(7-hydroxyheptyl)phosphino]propane,

1,3-bis[di(8-hydroxyoctyl)phosphino]propane,

1,3-bis{di[(3-hydroxycyclopentyl)propyl]phosphino}propane,

1,3-bis[di(5-sulfonatopentyl)phosphino]propane,

1,3-bis[di(6-sulfonatohexyl)phosphino]propane,

1,3-bis[di(7-sulfonatoheptyl)phosphino)propane,

1,3-bis[di(8-sulfonatooctyl)phosphino]propane,

1,3-bis{di[(3-sulfonatocyclopentyl)propyl]phosphino}propane,

1,3-bis[di(5-carboxypentyl)phosphino]propane,

1,3-bis[di(propylmalonoyl)phosphino]propane,

1,3-bis[di(6-carboxyhexyl)phosphino]propane,

1,3-bis[di(7-carboxyheptyl)phosphino]propane,

1,3-bis[di(8-carboxyoctyl)phosphino]propane,

N,N-bis[di(4-hydroxybutyl)phosphinomethyl]phenylamine,

N,N-bis[di(5-hydroxypentyl)phosphinomethyl]phenylamine,

N,N-bis[di(6-hydroxyhexyl)phosphinomethyl]phenylamine,

N,N-bis[di(7-hydroxyheptyl)phosphinomethyl phenylamine,

N,N-bis[di(8-hydroxyoctyl)phosphinomethyl]phenylamine,

N,N-bis{di[(3-hydroxycyclopentyl)propyl]}phenylamine,

N,N-bis[di(5-sulfonatopentyl)phosphinomethyl]phenylamine,

N,N-bis[di(6-sulfonatohexyl)phosphinomethyl]phenylamine,

N,N-bis[di(7-sulfonatoheptyl)phosphinomethyl]phenylamine,

N,N-bis[di(8-sulfonatooctyl)phosphinomethyl]phenylamine,

N,N-bis{di[(3-sulfonatocyclopentyl)propyl]phosphinomethyl}-phenylamine,

N,N-bis[di(5-carboxypentyl)phosphinomethyl]phenylamine,

N,N-bis[di(6-carboxyhexyl)phosphinomethyl]phenylamine,

N,N-bis[di(7-carboxyheptyl)phosphinomethyl]phenylamine,

N,N-bis[di(8-carboxyoctyl)phosphinomethyl]phenylamine and

1,3-bis[di(4-methylol-5-hydroxyisopentyl)phosphino]propane.

Particularly preferred among said chelate ligand compounds are those in which R¹ to R⁴ are each a hexyl, 4-methylpentyl, octyl, cyclopentyl or cyclohexyl radical substituted by a hydroxyl or carboxyl group.

Suitable metals M of the novel process are the metals of groups VIIIB, IB and IIB of the Periodic Table of the Elements, i.e. mainly the platinum metals, such as ruthenium, rhodium, osmium, iridium and platinum and very particularly preferably palladium, in addition to iron, cobalt and nickel. The metals may be present in the complexes according to the formula (I) in a formally uncharged form, in a form formally having a single positive charge, or, preferably, in a form formally having a double positive charge.

Suitable formally charged anionic ligands L¹, L² are hydride, halides, sulfates, phosphates or nitrates. Carboxylates or salts of organic sulfonic acids, such as methylsulfonate, trifluoromethylsulfonate or p-toluenesulfonate, are furthermore suitable. Among the salts of organic sulfonic acids, p-toluenesulfonate is preferred. Preferred formally charged ligands L¹, L² are carboxylates, preferably C₁- to C₂₀-carboxylates, in particular C₁- to C₇-carboxylates, e.g. acetate, trifluoroacetate, propionate, oxalate, citrate or benzoate. Acetate is particularly preferred.

Suitable formally charged organic ligands L¹, L² are also aliphatic C₁- to C₂₀-radicals, cycloaliphatic C₃- to C₁₄-radicals, C₇- to C₂₀-arylalkyl radicals having C₆- to C₁₄-aryl radicals and C₁- to C₆-alkyl radicals, and aromatic C₆- to C₁₄-radicals, for example methyl, ethyl, propyl, isopropyl, tert-butyl, n-pentyl, isopentyl, cyclohexyl, benzyl, phenyl and aliphatically or aromatically substituted phenyl radicals.

Suitable formally uncharged ligands L¹, L² are generally Lewis bases, i.e. compounds having at least one free electron pair. Lewis bases whose free electron pair or whose free electron pairs is or are present on a nitrogen or oxygen atom, for example nitriles, R—CN, ketones, ethers, alcohols or water, are particularly suitable. C₁- to C₁₀-nitriles, such as acetonitrile, propionitrile or benzonitrile, or C₂- to C₁₀-ketones, such as acetone or acetylacetone, or C₂- to C₁₀-ethers, such as dimethyl ether, diethyl ether or tetrahydrofuran, are preferably used. In particular, acetonitrile, tetrahydrofuran or water is used.

In principle, the ligands L¹ and L² may be present in any desired ligand combination, i.e. the metal complex (I) may contain, for example, a nitrate or an acetate radical, a p-toluenesulfonate and an acetate radical or a nitrate and a formally charged organic ligand, such as methyl. Preferably, L¹ and L² are present as identical ligands in the metal complexes.

Depending on the formal charge of the complex fragment containing the metal M, the metal complexes contain anions X. If the M-containing complex fragment is formally uncharged, the novel complex according to the formula (I) contains no anions X. Advantageously used anions X are those which have very little nucleophilic character, i.e. have a very small tendency to undergo a strong interaction with the central metal M, whether ionic, coordinate or covalent.

Suitable anions X are, for example, perchlorate, sulfate, phosphate, nitrate and carboxylates, for example acetate, trifluoroacetate, trichloroacetate, propionate, oxalate, citrate, benzoate, and conjugated anions of organosulfonic acids, such as methylsulfonate, trifluoromethylsulfonate and para-toluenesulfonate, and further tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate. Perchlorate, trifluoroacetate, sulfonates, such as methylsulfonate, trifluoromethylsulfonate or p-toluenesulfonate, tetrafluoroborate or hexafluorophosphate and in particular trifluoromethylsulfonate, trifluoroacetate, perchlorate or p-toluenesulfonate are preferably used.

Suitable defined metal complexes are, for example, the following palladium (II) acetate complexes:

[1,3-bis(di(hydroxyphenyl)phosphino)propane],

[1,3-bis(di(4-hydroxybutyl)phosphino)propane],

[1,3-bis(di(4-methylol-5-hydroxypentyl)phosphino)propane],

[1,3-bis(di(5-hydroxypentyl)phosphino)propane],

[1,3-bis(di(6-hydroxyhexyl)phosphino)propane),

[1,3-bis(di((3-hydroxycyclopentyl)propyl)phosphino)propane],

[1,3-bis(di(8-hydroxyoctyl)phosphino)propane],

[1,3-bis(di(3-hydroxycyclohexyl)propyl)phosphino)propane],

[1,3-bis(di(sulfonatophenyl)phosphino)propane],

[1,3-bis(di(4-sulfonatobutyl)phosphino)propane],

[1,3-bis(di(4-methylol-5-sulfonatopentyl)phosphino)propane],

[1,3-bis(di(5-sulfonatopentyl)phosphino)propane],

[1,3-bis(di(6-sulfonatohexyl)phosphino)propane],

[1,3-bis(di((3-sulfonatocyclopentyl)propyl)phosphino)propane],

[1,3-bis(di(8-sulfonatooctyl)phosphino)propane],

[1,3-bis(di((3-sulfonatocyclohexyl)propyl)phosphino)propane],

[1,3-bis(di(carboxyphenyl)phosphino)propane],

[1,3-bis(di(4-carboxybutyl)phosphino)propane],

[1,3-bis(di(4-methylol-5-carboxypentyl)phosphino)propane],

[1,3-bis(di(5-carboxypentyl)phosphino)propane],

[1,3-bis(di(6-carboxyhexyl)phosphino)propane],

[1,3-bis(di((3-carboxycyclopentyl)propyl)phosphino)propane],

[1,3-bis(di(8-carboxyoctyl)phosphino)propane], or

[1,3-bis(di(3-carboxycyclohexyl)propyl)phosphino)propane]-palladium(II) acetate.

The transition metal complexes described are soluble in water, at least in small amounts. As a rule, these metal complexes are readily to very readily soluble in water.

Defined metal complexes according to formula (I) can be prepared by the following processes.

For the neutral chelate complexes (p=0), the preparation is carried out by exchange of weakly coordinating ligands, for example 1,5-cyclooctadiene, benzonitrile or tetramethylethylenediamine, which are bonded to the corresponding transition metal compounds, for example transition metal halides, transition metal (alkyl)(halides), or transition metal diorganyls, for the chelate ligands of the formula (VIII) having the meanings described above.

The reaction is carried out in general in a polar solvent, for example acetonitrile, acetone, ethanol, diethyl ether, dichloromethane or tetrahydrofuran, or a mixture thereof at from −78 to 90° C.

Furthermore, neutral metal complexes according to formula (I), in which L¹ and L² are each carboxylate, e.g. acetate, can be prepared by reacting transition metal salts, for example palladium (II) acetate, with the chelate ligands (VIII) described in acetonitrile, acetone, ethanol, diethyl ether, dichloromethane, tetrahydrofuran or water at room temperature. Solvent mixtures may also be used.

A further suitable synthesis method is the reaction of the metal complexes of the formula (I) with organometallic compounds of groups IA, IIA, IVA and IIB, for example C₁- to C₆-alkyls of the metals lithium, aluminum, magnesium, tin or zinc, formally charged inorganic ligands L¹, L², as defined above, being exchanged for formally charged aliphatic, cycloaliphatic or aromatic ligands L¹, L², as likewise defined above. The reaction is carried out in general in a solvent, for example diethyl ether or tetrahydrofuran at from −78 to 65° C.

Monocationic complexes of the formula (I) (p=1) can be obtained, for example, by reacting (chelate ligand)metal(acetate)(organo) or (chelate ligand)metal(halo)(organo) complexes with stoichiometric amounts of a metal salt M′X. The reactions are carried out in general in coordinating solvents, for example acetonitrile, benzonitrile, tetrahydrofuran or ethers, at from −78 to 65° C.

It is advantageous if the metal salts M′X fulfill the following criteria. The metal M′ preferably forms sparingly soluble metal chlorides, for example silver chloride. The salt anion should preferably be non-nucleophilic anion X, as defined above.

Suitable salts for the formation of cationic complexes are, for example, silver tetrafluoroborate, silver hexafluorophosphate, silver trifluoromethanesulfonate, silver perchlorate, silver paratoluenesulfonate, silver trifluoroacetate and silver hexafluoroantimonate, sodium tetraphenylborate, sodium tetrakis(pentafluorophenyl)borate, silver trifluoroacetate or sodium tetrakis(3,5-bis(trifluoromethyl)phenyl)borate.

The dicationic complexes (p=2) are prepared analogously to the monocationic complexes, except that, instead of the (chelate ligand)metal(acetate)(organo) or the (chelate ligand)metal(halo)(organo) complexes, the (chelate ligand)metal(diacetate) or (chelate ligand)metal(dihalo) complexes are used as an intermediate, as well as two equivalents of the metal salt.

A further suitable process for the preparation of the dicationic complexes according to formula (I) is the reaction of [U₄M]X₂ with the chelate ligands of the formula (VIII) which are defined at the outset. Here, U are identical or different weak ligands, for example acetonitrile, benzonitrile or 1,5-cyclooctadiene, and M and X have the meanings defined above.

A preferred process for the preparation of the metal complexes of the formula (I) is the reaction of the dihalo-metal precursor complexes with silver salts containing noncoordinating anions.

The dispersants b) used according to the novel process may be emulsifiers or protective colloids.

Suitable protective colloids are, for example, polyvinyl alcohols, polyalkylene glycols, alkali metal salts of polyacrylic acids and polymethacrylic acids, cellulose derivatives and gelatin derivatives or copolymers containing acrylic acid, methacrylic acid, maleic anhydride, 2-acryloamido-2-methylpropanesulfonic acid and/or 4-styrenesulfonic acid and the alkali metal salts thereof, as well as homo- and copolymers containing N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amino-containing acrylates, methacrylates, acrylamides and/or methacrylamides. A detailed description of further suitable protective colloids is to be found in Houben-Weyl, Methoden der organischen Chemie, Volume XIV/1, Makromolekulare Stoffe, Georg-Thieme-Verlag, Stuttgart, 1961, pages 411 to 420.

Of course, mixtures of protective colloids and/or emulsifiers can also be used. Frequently, the dispersants used are exclusively emulsifiers whose relative molecular weights, in contrast to the protective colloids, are usually less than 1000. They may be either anionic, cationic or nonionic. Where mixtures of surfactants are used, the individual components must of course be compatible with one another, which, in case of doubt, can be checked by means of a few preliminary experiments. In general, anionic emulsifiers are compatible with one another and with nonionic emulsifiers. The same also applies to cationic emulsifiers, whereas anionic and cationic emulsifiers are generally not compatible with one another. An overview of suitable emulsifiers is to be found in Houben-Weyl, Methoden der organischen Chemie, Volume XIV/1, Makromolekulare Stoffe, Georg-Thieme-Verlag, Stuttgart, 1961, pages 192 to 208.

Customary nonionic emulsifiers are, for example, ethoxylated mono-, di- and trialkylphenols (degree of ethoxylation: 3 to 50, alkyl radical: C₄ to C₁₂) and ethoxylated fatty alcohols (degree of ethoxylation: 3 to 80; alkyl radical: C₈ to C₃₆). Examples of these are the Lutensol® A grades (C₁₂-C₁₄-fatty alcohol ethoxylates, degree of ethoxylation: 3 to 8), Lutensol® AO grades (C₁₃-C₁₅ oxo alcohol ethoxylates, degree of ethoxylation: 3 to 30), Lutensol® AT grades (C₁₆-C₁₄-fatty alcohol ethoxylates, degree of ethoxylation: 11 to 80), Lutensol® ON grades (C₁₀ oxo alcohol ethoxylates, degree of ethoxylation: 3 to 11) and the utensol® TO grades (C₁₃ oxo alcohol ethoxylates, degree of ethoxylation: 3 to 20) from BASF AG.

Customary anionic emulsifiers are, for example, alkali metal and ammonium salts of alkylsulfates (alkyl radical: C₉ to C₁₂), of sulfuric monoesters of ethoxylated alkanols (degree of ethoxylation: 4 to 30, alkyl radical: C₁₂ to C₁₈) and of ethoxylated alkylphenols (degree of ethoxylation: 3 to 50, alkyl radical: C₄ to C₁₂), of alkanesulfonic acids (alkyl radical: C₁₂ to C₁₈) and of alkylarylsulfonic acids (alkyl radical: C₉ to C₁₈).

Furthermore, compounds of the formula (XI)

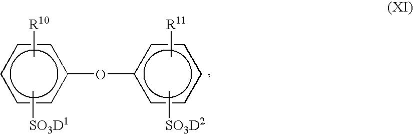

where R¹⁰ and R¹¹ are each hydrogen or C₄- to C₂₄-alkyl and are not simultaneously hydrogen and D¹ and D² may be alkali metal ions and/or ammonium ions, have proven useful as further anionic emulsifiers. In the formula (XI), R¹⁰ and R¹¹ are each preferably linear or branched alkyl of 6 to 18, in particular 6, 12 or 16, carbon atoms or hydrogen, R¹⁰ and R¹¹ not both simultaneously being hydrogen. D¹ and D² are preferably sodium, potassium or ammonium, sodium being particularly preferred. Particularly advantageous compounds (XI) are those in which D¹ and D² are sodium, R¹⁰ is branched alkyl of 12 carbon atoms and R¹¹ is hydrogen or R¹⁰. Frequently, industrial mixtures which contain from 50 to 90% by weight of the monoalkylated product are used, for example Dowfax® 2A1 (brand of Dow Chemical Company). The compounds (XI) are generally known, for example from U.S. Pat. No. 4,269,749, and are commercially available.

Suitable cationic emulsifiers are as a rule primary, secondary, tertiary or quaternary ammonium salts, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts which have a C₆- to C₁₈-alkyl, C₆- to C₁₈-alkylaryl or heterocyclic radical. Examples are dodecylammonium acetate and the corresponding sulfate, the sulfates and acetates of the various 2-(N,N,N-trimethylammonium)ethylparaffinic esters, N-cetylpyridinium sulfate, N-laurylpyridinium sulfate and N-cetyl-N,N,N-trimethylammonium sulfate, N-dodecyl-N,N,N-trimethylammonium sulfate, N-octyl-N,N,N-trimethylammonium sulfate, N,N-distearyl-N,N-dimethylammonium sulfate and the gemini surfactant N,N′-(lauryldimethyl)ethylenediamine disulfate, ethoxylated tallow fatty alkyl-N-methylammonium sulfate and ethoxylated oleylamine (for example Uniperol® AC from BASF AG, about 12 ethylene oxide units). Numerous further examples are to be found in H. Stache, Tensid-Taschenbuch, Carl-Hanser-Verlag, Munich, Vienna, 1981, and in McCutcheon's, Emulsifiers & Detergents, MC Publishing Company, Glen Rock, 1989. What is important is that the anionic opposite groups are very slightly nucleophilic, examples being perchlorate, sulfate, phosphate, nitrate and carboxylates, such as acetate, trifluoroacetate, trichloroacetate, propionate, oxalate, citrate, benzoate, and conjugated anions of organosulfonic acids, for example methylsulfonate, trifluoromethylsulfonate, and para-toluenesulfonate, and furthermore tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

Suitable hydroxy compounds c) are all substances which have one or more hydroxyl groups. Lower alcohols of 1 to 6 carbon atoms, such as methanol, ethanol, n-propanol, isopropanol, n-butanol, sec-butanol or tert-butanol are preferred. Aromatic hydroxy compounds, e.g. phenol, may also be used. For example, sugars, such as fructose, glucose or lactose, are also suitable. Polyalcohols, such as ethylene glycol, glycerol or polyvinyl alcohol, are furthermore suitable. It is of course also possible to use mixtures of a plurality of hydroxy compounds.

The novel copolymerization of carbon monoxide and at least one olefinically unsaturated compound in the presence of the metal complexes or of their individual components and of the dispersant b) is carried out in an aqueous medium. The copolymerization mixture is preferably vigorously and thoroughly mixed in order to obtain reproducibly good productivities.

The carbon monoxide copolymers can be obtained in principle by two different procedures. According to one preparation process, the abovementioned defined metal complexes a1) are used. These complexes are prepared separately and are added as such to the reaction mixture or are initially taken in the reaction container. In a further preparation process, the components forming the catalytically active species are added individually to the reaction mixture. In this in situ generation of the catalyst, the metal M is generally added in salt form or as a complex salt to the reaction vessel. Furthermore, the chelate ligand compound a1.2) is added. If required, an acid a2) and/or a hydroxy compound c) can be added as an activator compound in both procedures. The addition of the activator species can be dispensed with if the chelate ligand a1.2) has radicals R¹ to R⁴ which have at least one free sulfo or carboxyl group.

Frequently, the use of defined metal complexes a1) gives rise to higher productivity than with the in situ process.

According to the invention, those compounds which contain the structural element of the formula (III)

—CH═CH-Q-Polₙ (III)

are used as at least one olefinically unsaturated compound. A mixture of a compound containing the structural element of the formula (III) and of an olefinically unsaturated compound of 2 to 20 carbon atoms can also be used. According to the invention, mixtures of compounds containing the structural element of the formula (III) and mixtures of olefinically unsaturated compounds of 2 to 20 carbon atoms can of course also be used.

Q is a nonpolar organic group selected from the group consisting of linear or branched C₁- to C₂₀-alkyl, often C₂- to C₁₈-alkyl and frequently C₃- to C₁₄-alkyl, for example methyl, ethyl, n-propyl, isopropyl, or n-, iso- or tert-butyl, -pentyl, -hexyl, -heptyl, -octyl, -nonyl, -decyl, -undecyl, -dodecyl, -tridecyl or tetradecyl, C₃- to C₁₄-cycloalkyl, for example cyclopropyl, cyclobutyl, cyclopentyl or cyclohexyl, C₆- to C₁₄-aryl, for example phenyl, naphthyl or phenanthryl, and alkylaryl having 1 to 20 carbon atoms in the alkyl moiety and 6 to 14 carbon atoms in the aryl moiety, example benzyl.

π polar groups Pol are bonded to the nonpolar group Q. π is an integer not equal to 0. π is preferably 1, 2, 3 or 4. Of course, π may also have a higher numerical value. Pol is a polar radical which is selected from the group Consisting of carboxyl (—CO₂H), sulfonyl (—SO₃H), sulfate (—OSO₃H), phosphonyl (—PO₃H), phosphate (—OPO₃H₂) and their alkali metal salts, in particular sodium or potassium salts, alkaline earth metal salts, for example magnesium or calcium salts, and/or ammonium salts.

Pol also includes alkanolammonium, pyridinium, imidazolinium, oxazolinium, morpholinium, thiazolinium, quinolinium, isoquinolinium, tropylium, sulfonium, guanidinium and phosphonium compounds obtainable by protonation or alkylation and in particular ammonium compounds of the formula (IV)

—N^{⊕}R⁶R⁷R^{B} (IV).

Here, R⁶, R⁷ and R⁸, independently of one another, are each hydrogen or linear or branched C₁- to C₂₀-alkyl, frequently C₁- to C₁₀-alkyl and often C₁- to C₅-alkyl, alkyl being, for example, methyl, ethyl, n-propyl, isopropyl, or n-, iso- or tert-butyl, -pentyl, -hexyl, -heptyl, -octyl, -nonyl, -decyl, -undecyl, -dodecyl, -tridecyl or tetradecyl. The corresponding anions of the abovementioned compounds are non-nucleophilic anions, for example perchlorate, sulfate, phosphate, nitrate and carboxylates, such as acetate, trifluoroacetate, trichloroacetate, propionate, oxalate, citrate, benzoate, and conjugated anions of organosulfonic acids, for example methylsulfonate, trifluoromethylsulfonate and para-toluenesulfonate, and furthermore tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The polar radical Pol can, however, also be a group of the formula (V), (VI) or (VII)

-(EO)ₖ—(PO)ₗ—R⁹ (V),

—(PO)ₗ—(EO)ₖ—R⁹ (VI),

-(EOₖ/POₗ)—R⁹ (VII),

where

EO is a —CH₂—CH₂—O— group,

PO is a —CH₂—CH(CH₃)—O— or a —CH(CH₃)—CH₂—O— group and k and l are from 0 to 50, frequently from 0 to 30 and often from 0 to 15, where k and l are not simultaneously 0.

Furthermore, in

| | |
|---|---|
| formulae (V) and (VI): | (EO)ₖ should be a block of k —CH₂—CH₂—O— |
| | groups |
| | and |
| | (PO)₁ should be a block 1 —CH₂—CH(CH₃)— |
| | O— or —CH(CH₃)—CH₂—O—groups, and |
| formula (VII): | (EOₖ/PO₁) should be a mixture k |
| | —CH₂—CH₂—O—groups and |
| | 1 —CH₂—CH(CH₃)—O— or —CH(CH₃) |
| | —CH₂—O— groups in random distribution. |

R⁹ is hydrogen, linear or branched C₁- to C₂₀-alkyl, often C₁- to C₁₀-alkyl, frequently C₁- to C₆-alkyl, or -SO₃H or its corresponding alkali metal, alkaline earth metal and/or ammonium salt. Here, alkyl is, for example, methyl, ethyl, n-propyl, isopropyl, or n-, iso- or tert-butyl, -pentyl, -hexyl, -heptyl, -octyl, -nonyl, -decyl, -undecyl, -dodecyl, -tridecyl or tetradecyl, alkali metal is, for example sodium or potassium and alkaline earth metal is, for example, calcium or magnesium.

According to the invention, in particular a-olefins of the formula (X)

H₂C═CH-Q-Pol_{π} (X),

where Q, Pol and π have the abovementioned meanings, are used as at least one compound containing the structural element of the formula (III).

Preferred olefins (X) are 10-undecenoic acid, 3-butenoic acid, 4-pentenoic acid, 5-hexenoic acid and styrene-4-sulfonic acid.

In addition to the at least one compound containing the structural element of the formula (III), it is possible to use at least one further olefinically unsaturated monomer compound for the polymerization. Both pure hydrocarbon compounds and heteroatom-containing α-olefins, such as (meth)acrylates or (meth)acrylamides and homoallyl or allyl alcohols, ethers or halides are suitable as at least one further olefinically unsaturated monomer compound in the novel process for the preparation of aqueous copolymer dispersions. Among the pure hydrocarbons, 1-C₂- to C₂₀-alkenes are suitable. Among these, the low molecular weight olefins, e.g. ethene or α-olefins of 3 to 8 carbon atoms, such as propene, 1-butene, 1-pentene, 1-hexene or 1-octene, are noteworthy. It is of course also possible to use cyclic olefins, e.g. cyclopentene or norbornene, aromatic olefin compounds, such as styrene or α-methylstyrene, or vinyl esters, such as vinyl acetate. Where at least two olefins different from one another are used, 1-C₂- to C₂₀-alkenes are particularly suitable. Among these, the low molecular weight olefins, e.g. ethene or α-olefins of 3 to 8 carbon atoms, such as propene, 1-butene, 1-pentene, 1-hexene or 1-octene, are noteworthy.

Examples of preferred further olefinically unsaturated monomer compounds of 2 to 20 carbon atoms are ethene, propene, 1-butene, 1-hexene, 1-octene and 1-decene, 1-dodecene, 1-tetradecene, 1-hexadecene and 1-octadecene.

The amount of the at least one olefinically unsaturated compound containing the structural element of the formula (III) in the monomer mixture to be polymerized, consisting of the at least one said olefinically unsaturated compound and, if required, the at least one further olefinically unsaturated monomer compound of 2 to 20 carbon atoms, is from 0.1 to 100, frequently from 0.5 to 80, often from 1.0 to 60 or from 2.0 to 40, % by weight.

According to the invention, it is possible initially to take the total amount of the at least one olefinically unsaturated compound in the polymerization reactor. However, it is also possible, if required, initially to take only a portion of the at least one olefinically unsaturated compound in the polymerization reactor and to add the remaining amount continuously or batchwise during the polymerization or to add the total amount continuously or batchwise during the polymerization. If it is intended to use mixtures of at least one compound containing the structural element of formula (III) and at least one olefinically unsaturated compound of 2 to 20 carbon atoms for polymerization, a portion or the total amount of the compounds to be polymerized can be initially taken in the polymerization reactor and any remaining amounts added continuously or batchwise during the polymerization. Of course, it is also possible to add the different olefinically unsaturated compounds in a gradient procedure. This is understood as meaning that the ratio of the olefinically unsaturated compounds to one another changes during the olefin metering.

What is important is that the novel process can be carried out both batchwise, for example in stirred autoclaves, and continuously, for example in tubular reactors, loop reactors or stirred kettle cascades.

The aqueous copolymer dispersions obtainable according to the invention are stable over several weeks or months and as a rule show virtually no phase separation, deposition or coagulum formation during this time.

The molar ratio of carbon monoxide to the at least one olefinically unsaturated compound is as a rule from 10:1 to 1:10, usually from 5:1 to 1:5 or from 2:1 to 1:2.

The copolymerization temperature is generally set in a range from 0 to 200° C., preferably from 20 to 130° C. The carbon monoxide partial pressure is in general from 1 to 300, in particular from 10 to 220 bar. It is advantageous if the partial pressure of the at least one olefinically unsaturated compound under reaction conditions is less than the carbon monoxide partial pressure. In particular, the partial pressure of the at least one olefinically unsaturated compound under reaction conditions is ≦50%, ≦40%, ≦30% or even ≦20%, based in each case on the total pressure. The polymerization reactor is usually provided with an inert atmosphere by flushing with carbon monoxide or inert gas, for example nitrogen or argon, before carbon monoxide is forced in under pressure. Frequently, however, polymerization is also possible without prior provision of an inert atmosphere.

Suitable acids a2) can be employed as activator compounds for activating the catalyst. Suitable activator compounds are both mineral protic acids and Lewis acids. Suitable protic acids are, for example, sulfuric acid, nitric acid, boric acid, tetrafluoroboric acid, perchloric acid, p-toluenesulfonic acid, trifluoroacetic acid, trifluoromethanesulfonic acid and methanesulfonic acid. p-Toluenesulfonic acid and tetrafluoroboric acid are preferably employed.

Examples of suitable Lewis acids a2) are boron compounds, such as triphenylborane, tris(pentafluorophenyl)borane, tris(p-chlorophenyl)borane and tris(3,5-bis(trifluoromethyl)phenyl)borane and aluminum, zinc, antimony and titanium compounds having a Lewis acid character. It is also possible to use mixtures of protic acids or Lewis acids, and protic and Lewis acids in the form of a mixture.

The molar ratio of activator to metal complex a1) is from 60:1 to 1:1, preferably from 25:1 to 2:1, and particularly preferably from 12:1 to 3:1, based on the amount of metal M, for the cases where the functional groups of the radicals R¹ to R⁴ are not sulfone or carboxyl functional groups. Of course, activator compound a2) can be added to the polymerization mixture also in the case of metal complexes having chelate ligands which carry the abovementioned functional acid groups.

The emulsifier used as dispersant b) is advantageously employed in an amount of from 0.005 to 10, preferably from 0.01 to 7, in particular from 0.1 to 5, % by weight, based on the total amount of the monomers.

The amount of the protective colloids used additionally or instead as dispersant b) is often from 0.1 to 10, frequently from 0.2 to 7, % by weight, based on the total amount of monomers.

The molar ratio of hydroxy compound c) to metal complex a1) is in general from 0 to 100 000, often from 500 to 50 000, frequently from 1 000 to 10 000, based on the amount of metal M.

In the novel polymerization process, the mean catalyst activities obtained are in general >0.17, frequently >0.25, often >0.5, kg of copolymer per gram of complex metal per hour.

According to the invention, copolymers whose number average particle diameter, determined by quasielastic light scattering (ISO Standard 13321), is from 1 to 2 000 nm, frequently from 10 to 1 500 nm and often from 15 to 1 000 nm, are obtained.

The weight average molecular weights of the copolymers obtainable according to the invention, determined by means of gel permeation chromatography used in polymethyl methacrylate as standard, are from 1 000 to 1 000 000, frequently from 1 500 to 800 000 and often from 2 000 to 600 000.

As shown by ¹³C-NMR or ¹H-NMR spectroscopic investigations, the copolymers obtainable by the novel process are as a rule linear, alternating carbon monoxide copolymers. These are to be understood as meaning polymers in which, in the polymer chain, each carbon monoxide unit is followed by a —CH₂—CH— or CH—CH— unit originating from the olefinic double bond of the at least one olefinically unsaturated compound and each —CH₂—CH— or CH—CH— unit is followed by a carbon monoxide unit. In particular, the ratio of carbon monoxide units to —CH₂—CH— or CH—CH— units is as a rule from 0.9:1 to 1:0.9, frequently from 0.95:1 to 1:0.95 and often from 0.98:1 to 1:0.98.

By a specific variation of the olefinically unsaturated compounds, it is possible, according to the invention, to prepare copolymers whose glass transition temperature or melting point is from −60 to 270° C.

The glass transition temperature T_{g} is intended to mean the limit of the glass transition temperature to which the latter tends with increasing molecular weight, according to G. Kanig (Kolloid-zeitschrift & Zeitschrift für Polymere, Vol. 190, page 1, equation 1). The glass transition temperature is determined by the DSC method (Differential Scanning Calorimetry, 20 K/min, midpoint measurement, DIN 53765).

According to Fox (T. G. Fox, Bull. Am. Phys. Soc. (1956) [Ser. II] 1, 123 and according to Ullmann's Encyclopadie der technischen Chemie, Vol. 19, page 18, 4th edition, Verlag Chemie, Weinheim, 1980), the following is a good approximation for the glass transition temperature of at most weakly crosslinked copolymers:

1/T_{g}=x¹/T_{g}¹+x²/T_{g}²+ . . . . xⁿ/T_{g}ⁿ,

where x¹, x², . . . xⁿ are the mass fractions of the monomers 1, 2, . . . n and T_{g}¹, T_{g}² . . . T_{g}ⁿ are the glass transition temperatures, in degrees Kelvin, of the polymers composed in each case only of one of the monomers 1, 2, . . . n. The T_{g} values for the homopolymers of most monomers are known and are stated, for example, in Ullmann's Encyclopedia of Industrial Chemistry, Vol. 5, Vol. A21, page 169, VCH Weinheim, 1992; other sources of glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3^{rd} Ed. J. Wiley, New York 1989.

The novel copolymer dispersions have, as a rule, the minimum film formation temperatures MFT≦80° C., preferably ≦50° C., particularly preferably ≦30° C. As the MFT is no longer measurable below 0° C., the lower limit of the MFT can be specified only by the Tg values. The MFT is determined according to DIN 53787.

The novel process gives aqueous copolymer dispersions whose solids content is from 0.1 to 70, frequently from 1 to 65, often from 5 to 60, % by weight and all values in between, based on the aqueous copolymer dispersion.

Of course, the residual monomers remaining in the aqueous copolymer dispersion at the end of the main polymerization reaction can be removed by stripping with steam and/or with inert gas, without the polymer properties of the aqueous copolymer dispersion changing in a disadvantageous manner.

The catalytic metal complex can, if required, also be removed from the aqueous copolymer dispersion obtainable according to the invention. For this purpose, the disperse copolymer can, for example, be separated from the aqueous serum by centrifuging, be redispersed by addition of neutral, acidic and/or basic water, be centrifuged again, etc., the water-soluble metal complex accumulating in the serum in each case. In addition, it is often also possible to remove the metal complex by dialysis methods.

Aqueous copolymer dispersions which are prepared by the novel process described are stable over several weeks or months and exhibit virtually no phase separation, deposition or coagulum formation during this time. They are very useful in particular as binders in the preparation of adhesives, for example contact adhesives, construction adhesives or industrial adhesives, sealing compounds, plastics renders and coating materials, for example for paper coating, emulsion paints or printing inks and printing lacquers for printing on plastics films and for the production of nonwovens or for the production of protective layers and water vapor barriers, for example for priming.

It should also be noted that the aqueous copolymer dispersions obtainable according to the invention can be dried in a simple manner to give redispersible copolymer powders (for example by freeze-drying or spray-drying). This applies in particular when the glass transition temperature of the copolymers is ≧50° C., preferably ≧60° C., particularly preferably ≧70° C., very particularly preferably ≧80° C., and especially preferably ≧90° C. or ≧100° C. The copolymer powders are also suitable as binders in adhesives, sealing compounds, plastics renders and coating materials and for the production of nonwovens or for the modification of mineral binders, for example mortar or cement, and as modifying additives in other plastics.

With the aid of the novel processes, the use of organic solvents and even halogenated or aromatic hydrocarbons is avoided. Moreover, there is no need for expensive separation operations. The novel process accordingly opens up an economical, ecological, preparatively simple and substantially safe route to linear, alternating carbon monoxide copolymers. The novel process is particularly effective with regard to achievable catalyst activities, molecular weights and their distribution and, in the presence of a plurality of different olefins, with respect to the achievable incorporation rates of higher olefins.

The examples which follow illustrate the invention.

### EXAMPLES

1 Preparation of the Metal Complex

1.1 Preparation of Propane 1,3-bis(diethyl phosphonite)

674 g of triethyl phosphite (98% by weight, from Aldrich) were added to 204 g of 1,3-dibromopropane (99% by weight, from Aldrich) at from 20 to 25° C. (room temperature) and the mixture is slowly heated to 140° C. while stirring. The bromoethane forming was removed by distillation. After the liberation of bromoethane had died down, the reaction temperature was increased to 155° C. and the reaction mixture was kept at this temperature for 24 hours while stirring. Thereafter, a further 674 g of triethyl phosphite were added dropwise and the reaction was stopped after a further 24 hours by separating off excess triethyl phosphite by distillation. Monosubstituted product was removed by distillation at 150° C. under greatly reduced pressure [0.1 mbar (absolute)]. The remaining distillation residue was propane 1,3-bis(diethyl phosphonite). The yield was 271 g, corresponding to 86% by weight, based on 1,3-dibromopropane.

1.2 Preparation of 1,3-diphosphinopropane

A solution consisting of 103.3 g of propane 1,3-bis(diethylphosphonite) in 100 ml of anhydrous diethyl ether saturated with argon was added to a suspension of 25 g LiAlH₄ (95% by weight, from Aldrich) in 200 ml of anhydrous diethyl ether in the course of 180 minutes at 0° C. while stirring. Thereafter, the reaction temperature was increased to room temperature and the reaction mixture was stirred for 16 hours at this temperature. 200 ml of degassed 6 molar aqueous hydrochloric acid saturated with argon were then slowly added to hydrolyze excess LiAlH₄. The organic phase was then separated off and was dried for 24 hours over sodium sulfate. The aqueous phase was thoroughly mixed with 200 ml of diethyl ether and, after phase separation, the diethyl ether phase was likewise dried for 24 hours over sodium sulfate. The two diethyl ether phases were then combined. After the diethyl ether had been separated off by distillation at 60° C./1 bar (absolute), 1,3-diphosphinopropane was obtained by distillation at 140° C./1 bar (absolute). The yield was 20 g, corresponding to 61% by weight, based on propane 1,3-bis(diethylphosphonite).

1.3 Preparation of 1,3-bis(di-5-hydroxypentyl)phosphinopropane

1.08 g of 1,3-diphosphinopropane and 4.47 g of 5-penten-1-ol (the preparation of which was carried out analogously to organikum, 18^{th} edition, Deutscher verlag der Wissenschaften, 1990, by alkylation of diethyl malonate with allyl bromide [page 518] via hydrolysis to give the dicarboxylic acid [page 415], decarboxylation to give the 4-pentenoic acid [page 416] and subsequent reduction with LiAlH₄ [page 492]), which was degassed and saturated with argon several times, were mixed at room temperature and exposed to UV light from a mercury high-pressure lamp (200 W) in a quartz Schlenk tube for 24 hours. Excess 5-penten-1-ol was then distilled off at 60° C./20 mbar (absolute) in a rotary evaporator. 4.34 g, corresponding to 96% by weight, based on 1,3-diphosphinopropane, of 1,3-bis(di-5-hydroxypentyl)phosphinopropane remained as residue.

1.4 Preparation of [1,3-bis(di-5-hydroxypentyl)phosphinopropane]palladium (II) Acetate

0.9 g of 1,3-bis(di-5-hydroxypentyl)phosphinopropane was dissolved in 10 ml of tetrahydrofuran (99.9% by weight; from Merck) repeatedly degassed and saturated with argon and slowly added dropwise to a solution of 0.44 g of palladium(II) acetate in 15 ml of tetrahydrofuran degassed and saturated with argon. To complete the reaction, stirring was carried out for a further 20 minutes at room temperature. The solvent mixture was removed at 60° C./0.1 mbar (absolute) and the defined palladium complex was isolated as a brownish yellow, highly viscous oil. 1.30 g of palladium complex, corresponding to 98% by weight, based on palladium(II) acetate, were obtained.

2. Polymerization Examples

### Example 1

10 mg of [1,3-bis(di-5-hydroxypentyl)phosphinopropane]palladium (II) acetate were dissolved, at room temperature under inert nitrogen gas, in 30 ml of demineralized and degassed water in a 100 ml one-necked flask having a nitrogen tap and were acidified with 26 mg of 50% strength by weight aqueous tetrafluoroboric acid (from Merck). 11.5 g of 10-undecenoic acid (98% by weight; from Aldrich), 2 ml of methanol (99.9% by weight) and 0.3 g of sodium dodecyl sulfate were added to this solution under a nitrogen atmosphere and completely emulsified by means of a magnetic stirrer (500 revolutions per minute, 10 minutes). The emulsion was transferred to a 100 ml steel autoclave having a magnetic stirrer, and the air was displaced by flushing several times with carbon monoxide. At room temperature, 60 bar carbon monoxide was forced in and the reaction mixture was then heated to 60° C. while stirring (500 revolutions per minute) and stirred for 12 hours at this temperature. Thereafter, the reaction mixture was cooled to room temperature and the steel autoclave was let down to 1 bar (absolute). The aqueous copolymer dispersion obtained was stable and showed no phase separation, deposition or coagulum formation over 10 weeks.

The coagulum content was generally determined by filtering the resulting aqueous copolymer dispersion through a 45 μm filter fabric. The filter fabric was then washed with 50 ml of demineralized water and was dried at 100° C./1 bar (absolute) to constant weight. The coagulum content was determined from the difference between the weight of the filter fabric before the filtration and that of the filter fabric after the filtration and the drying. In the present case, a coagulum content of <0.1% by weight, based on the aqueous polymer dispersion, was found.

The solids content was generally determined by drying about 1 g of the aqueous copolymer dispersion to constant weight in an open aluminum crucible having an internal diameter of about 3 cm in a drying oven at 100° C. and 10 mbar. In order to determine the solids content, in each case two separate measurements were carried out and the corresponding mean value was calculated. In the present case, the solids content was 25% by weight, based on the aqueous copolymer dispersion.

From the solids content, the mean catalyst activity was calculated at 390 grams of copolymer per gram of palladium per hour.

The number average particle diameter of the copolymer particles was generally determined by dynamic light scattering on a 0.005 to 0.01 percent strength by weight aqueous dispersion at 23° C. by means of an Autosizer IIC from Malvern Instruments, England. The mean diameter of the cumulant z-average of the measured autocorrelation function (ISO Standard 13321) is stated. In the present case, the average particle diameter was 270 nm.

The glass transition temperature of the melting point was generally determined according to DIN 53765 by means of a DSCS820 apparatus, series TA800, from Mettler-Toledo. In the present case, the glass transition temperature was −18° C.

### Example 2

10 mg of [1,3-bis(di-5-hydroxypentyl)phosphinopropane) palladium (II) acetate were dissolved, at room temperature under inert nitrogen gas, in 100 ml of demineralized and degassed water in a 250 ml one-necked flask having a nitrogen tap and were acidified with 26 mg of 50% strength by weight aqueous tetrafluoroboric acid (from Merck). 30 g of 1-hexene (97% by weight; Aldrich), 5 g of 10-undecenoic acid and 1.0 g of sodium dodecyl sulfate were added to this solution under a nitrogen atmosphere and completely emulsified by means of a magnetic stirrer (500 revolutions per minute, 10 minutes). The emulsion was transferred to a 300 ml steel autoclave having a rod stirrer, and the air was displaced by flushing several times with carbon monoxide. At room temperature, 60 bar carbon monoxide was forced in and the reaction mixture was then heated to 60° C. while stirring (500 revolutions per minute) and stirred for 10 hours at this temperature. Thereafter, the reaction mixture was cooled to room temperature and the steel autoclave was let down to 1 bar (absolute). Unconverted alkene was separated from the aqueous copolymer dispersion in a separating funnel, about 110 g of said dispersion being obtained. The coagulum content of the aqueous polymer dispersion was <0.1% by weight. The solids content was determined as 14% by weight, corresponding to a mean catalyst activity of 980 grams of copolymer per gram of palladium per hour. The number average particle diameter was 100 nm. In addition, the glass transition temperature was determined as −35° C. The aqueous copolymer dispersion obtained was stable and showed no phase separation, deposition or coagulum formation over 10 weeks.

Comparative Example

The preparation of the comparative example was carried out analogously to example 2, except that no 10-undecenoic acid was used. After phase separation, about 110 g of aqueous copolymer dispersion having a solids content of 9% by weight were obtained. The coagulum content of the aqueous copolymer dispersion was about 5% by weight and the number average particle diameter was determined as 80 nm. In addition, a glass transition temperature of −30° C. was determined. What is important, however, is that the aqueous copolymer dispersion obtained was unstable and incipient copolymer separation (i.e. creaming) was observed within a few hours.

### Example 3

Example 3 was carried out analogously to example 2, except that no 1-hexene was used and 30 bar carbon monoxide and 30 bar ethene were forced in instead of 60 bar carbon monoxide.

The aqueous copolymer dispersion obtained had a solids content of 8% by weight, corresponding to a mean catalyst activity of 500 g of copolymer per gram of palladium per hour. The coagulum content was determined as <0.1% by weight and the number average particle diameter as 500 nm. The copolymer formed had a melting point of 210° C.

In addition, the aqueous copolymer dispersion obtained was stable and showed no phase separation, deposition or coagulum formation over 10 weeks.

### Example 4

Example 4 was carried out analogously to example 3, except that 30 g of 10-undecenoic acid were used instead of 5 g, and 9 bar propene was forced in instead of 30 bar ethene and 51 bar carbon monoxide instead of 30 bar carbon monoxide.

The aqueous copolymer dispersion obtained had a solids content of 17% by weight, corresponding to a mean catalyst activity of 1070 g of copolymer per gram of palladium per hour. The coagulum content was determined as <0.1% by weight and the number average particle diameter as 430 nm. The copolymer formed had a glass transition temperature of −10° C.

In addition, the aqueous copolymer dispersion obtained was stable and showed no phase separation, deposition or coagulum formation over 10 weeks.

### Example 5

Example 5 was carried out analogously to example 3, except that 15 mg of [1,3-bis(di-5-hydroxypentyl)phosphinopropane] palladium(II) acetate were used instead of 10 mg, 31 mg of 50% strength by weight aqueous tetrafluoroboric acid were used instead of 26 mg, 30 g of 1-butene were used instead of ethene and 60 bar carbon monoxide was forced in instead of 30 bar carbon monoxide.

The aqueous copolymer dispersion obtained had a solids content of 14% by weight, corresponding to a catalyst activity of 730 g of copolymer per gram of palladium per hour. The coagulum content was determined as <0.1% by weight and the number average particle diameter as 380 nm. The copolymer formed had a glass transition temperature of −17° C.

In addition, the aqueous copolymer dispersion obtained was stable and showed no phase separation, deposition or coagulum formation over 10 weeks.

We claim:

1. A process for the preparation of aqueous copolymer dispersions of copolymers of carbon monoxide and at least one olefinically unsaturated compound, wherein the copolymerization of carbon monoxide and at least one olefinically unsaturated compound is carried out in an aqueous medium in the presence of
a1) metal complexes of the formula (I) 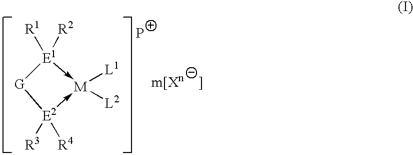
wherein
G is a 5-, 6- or 7-atom carbocyclic ring system with or without one or more heteroatoms, —(CR^{b}₂)ᵣ—, —(CR^{b}₂)ₛ—Si(R^{a})₂—(CR^{b}₂)ₜ—, -A-O-B— or -A-Z(R⁵)—B—,
R⁵ is hydrogen, or is C₁- to C₂₀-alkyl, C₃- to C₁₄-cycloalkyl, C₆- to C₁₄-aryl or alkylaryl having 1 to 20 carbon atoms in the alkyl radical and 6 to 14 carbon atoms in the aryl radical, which are unsubstituted or substituted by functional groups which contain atoms of groups IVA, VA, VIA or VIIA of the Periodic Table of the Elements, —N(R^{b})₂, —Si(R^{c})₃ or a radical of the formula (II) 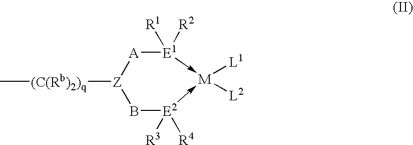
where
q is an integer from 0 to 20 and the further substituents in formula (II) have the same meanings as those in formula (I),
A, B are each —(CR^{b}₂)_{r′}—, —(CR^{b}₂)ₛ—Si(R^{a})₂—(CR^{b}₂)ₜ—, —N(R^{b})—, an r′-, s- or t-atom component of a ring system or, together with Z, an (r′+1)-, (s+1)- or (t+1)-atom component of a heterocyclic structure,
R^{a} independently of one another, are linear or branched C₁- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, it also being possible for said radicals to be substituted,
R^{b} has the same meanings as R^{a}, and may additionally be hydrogen or —Si(RC)₃,
R^{c} independently of one another, are linear or branched C₁- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, it also being possible for said radicals to be substituted,
r is 1, 2, 3 or 4 and
r′ is 1 or 2,
s, t are each 0, 1 or 2, where 1≦s+t≦3,
z is a nonmetallic element from group VA of the Periodic Table of the Elements,
M is a metal selected from the groups VIIIB, IB or IIB of the Periodic Table of the Elements,
E¹, E² are each a nonmetallic element from group VA of the Periodic Table of the Elements,
R¹ to R⁴ independently of one another, are each linear or branched C₂- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, at least one of the radicals R¹ to R⁴ having at least one hydroxyl, amino or acid group or containing an ionic functional group,
L¹, L² are formally charged or neutral ligands,
X are formally monovalent or polyvalent anions,
p is 0, 1, 2, 3 or 4,
m, n are each 0, 1, 2, 3 or 4,
where p is m x n,
b) a dispersant and, if required,
c) a hydroxy compound
and a compound containing the structural element of the formula (III)
—CH═CH-Q-Polₓ (III),
or a mixture of a compound containing the structural element of the formula (III) and an olefinically unsaturated compound of 2 to 20 carbon atoms is used as at least one olefinically unsaturated compound,
where
Q is a nonpolar organic group selected from the group consisting of linear or branched C₁- to C₂₀-alkyl, C₃- to C₁₄-cycloalkyl, C₆- to C₁₄-aryl, alkylaryl having 1 to 20 carbon atoms in the alkyl moiety and 6 to 14 carbon atoms in the aryl moiety and
π is an integer not equal to 0, and is preferably 1, 2, 3 or 4, and
Pol is a polar radical selected from the group consisting of
carboxyl, sulfonyl, sulfate, phosphonyl, phosphate and the alkali metal, alkaline earth metal and/or ammonium salts thereof,
alkanolammonium, pyridinium, imidazolinium, oxazolinium, morpholinium, thiazolinium, quinolinium, isoquinolinium, tropylium, sulfonium, guanidinium and phosphonium compounds and ammonium compounds of the formula (IV)
—N^{⊕}R⁶R⁷R⁸ (IV),
where
R⁶, R⁷ and R⁸, independently of one another, are each hydrogen or linear or branched C₁- to C₂₀-alkyl, or
a group of the formula (V), (VI) or (VII)
-(EO)ₖ—(PO)ₗ—R⁹ (V),
—(PO)ₗ-(EO)ₖ—R⁹ (VI),
-(EOₖ/POₗ)—R⁹ (VII),
where
EO is a —CH₂—CH₂—O— group,
PO is a —CH₂—CH(CH₃)—O— or a —CH(CH₃)—CH₂—O— group,
k and l are each from 0 to 50, but k and l are not simultaneously 0, and
R⁹ is hydrogen, independently of one another, linear or branched C₁- to C₂₀-alkyl or —SO₃H or the corresponding alkali metal, alkaline earth metal and/or ammonium salts thereof.

2. A process as claimed in claim 1, wherein the copolymerization is carried out in the presence of
a1) metal complexes of the formula (I),
a2) an acid,
b) a dispersant and, if desired,
c) a hydroxy compound.

3. A process for the preparation of aqueous copolymer dispersions of copolymers of carbon monoxide and at least one olefinically unsaturated compound, wherein the copolymerization of carbon monoxide and at least one olefinically unsaturated compound is carried out in an aqueous medium in the presence of
a1.1) a metal M, selected from group VIIIB, IB or IIB of the Periodic Table of the Elements, which is present in salt form or as a complex salt,
a1.2) a chelate ligand of the formula (VIII)
(R¹)(R²)E¹-G-E²(R³)(R⁴) (VIII),
where
G is a 5-, 6- or 7-atom carbocyclic ring system with or without one or more heteroatoms, (CR^{b}₂)ᵣ—, —(CR^{b}₂)ₛ—Si(R^{a})₂—(CR^{b}₂)ₜ—, -A-O-B— or -A-Z(R⁵)—B—,
R⁵ is hydrogen, or is C₁- to C₂₀-alkyl, C₃- to C₁₄-cycloalkyl, C₆- to C₁₄-aryl or alkylaryl having 1 to 20 carbon atoms in the alkyl radical and 6 to 14 carbon atoms in the aryl radical, which are unsubstituted or substituted by functional groups which contain atoms of groups IVA, VA, VIA or VIIA of the Periodic Table of the Elements, —N(R^{b})₂, —Si(R^{c})₃ or a radical of the formula (IX) 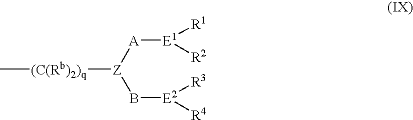
where
q is an integer from 0 to 20 and the further substituents in formula (IX) have the same meanings as those in formula (II),
A, B are each —(CR^{b}₂)_{r′}— or —(CR^{b}₂)S—Si(R^{a})₂—(CR^{b}₂)ₜ— or —N(R^{b})—, an r′-, s- or t-atom component of a ring system or, together with Z, an (r′+1)-, (s+1)- or (t+1)-atom component of a heterocyclic structure,
R^{a} independently of one another, are linear or branched C₁- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, it also being possible for said radicals to be substituted,
R^{b} has the same meanings as R^{a}, and may additionally be hydrogen or -Si(RC)₃,
R^{c} independently of one another, are linear or branched C₁- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, it also being possible for said radicals to be substituted,
r is 1, 2, 3 or 4,
r′ is 1 or 2,
s and t are each 0, 1 or 2, where 1≦s+t≦3,
z is a nonmetallic element from group VA of the Periodic Table of the Elements,
E¹ and E² are each a nonmetallic element from group VA of the Periodic Table of the Elements,
R¹ to R⁴ independently of one another, are linear or branched C₂- to C₂₀-alkyl, C₃- to C₁₄-cycloalkyl, C₆- to C₁₄-aryl or alkylaryl having 1 to 20 carbon atoms in the alkyl moiety and 6 to 14 carbon atoms in the aryl moiety, at least one of the radicals R¹ to R⁴ having at least one hydroxyl, amino or acid group or containing an ionic functional group,
b) a dispersant and, if required,
c) a hydroxy compound
and a compound containing the structural element of the formula (III) or a mixture of a compound containing the structural element of the formula (III) and an olefinically unsaturated compound of 3 to 20 carbon atoms is used as at least one olefinically unsaturated compound.

4. A process as claimed in claim 3, wherein the copolymerization is carried out in the presence of
a1.1) a metal M selected from the group VIIIB, IB or IIB of the Periodic Table of the Elements, which is present in salt form or as a complex salt,
a1.2) a chelate ligand of the formula (VIII),
a2) an acid,
b) a dispersant and, if required,
c) a hydroxy compound.

5. A process as claimed in any of claims 1 to 4, wherein an α-olefin of the formula (X)
H₂C═CH-Q-Pol_{π} (X)
is used as a compound containing the structural element of the formula (III).

6. A process as claimed in any of claims 1 to 5, wherein the hydroxy compound c) is a monohydric or polyhydric alcohol and/or a sugar.

7. A process as claimed in claims 2 and 4, wherein the acid used is a Lewis acid selected from the group consisting of boron trifluoride, antimony pentafluoride and triarylboranes or a protic acid selected from the group consisting of sulfuric acid, p-toluene sulfonic acid, tetrafluoroboric acid, trifluoromethanesulfonic acid, perchloric acid and trifluoroacetic acid.

8. A process as claimed in any of claims 1 to 7, wherein R¹ to R⁴ are linear, branched or carbocycle-containing C₂- to C₂₀-alkyl units, C₃- to C₁₄-cycloalkyl units, C₆- to C₁₄-aryl units or alkylaryl units having 1 to 20 carbon atoms in the alkyl moiety and 6 to 14 carbon atoms in the aryl moiety, and at least one of the radicals R¹ to R⁴ has at least one hydroxyl, amino, carboxyl, phosphoric acid, ammonium or sulfo group.

9. A process as claimed in claim 1 or 3, wherein R¹ to R⁴ are linear, branched or carbocycle-containing C₂- to C₂₀-alkyl units, C₃- to C₁₄-cycloalkyl units, C₆- to C₁₄-aryl units or alkylaryl units having 1 to 20 carbon atoms in the alkyl moiety and 6 to 14 carbon atoms in the aryl moiety, and at least one of the radicals R¹ to R⁴ is substituted by at least one free carboxyl or sulfo group.

10. A process as claimed in any of claims 1 to 9, wherein the dispersant b) used is an anionic, cationic and/or nonionic emulsifier.

11. An aqueous copolymer dispersion prepared by a process as claimed in any of claims 1 to 10.

12. An aqueous copolymer dispersion containing a copolymer of carbon monoxide and at least one olefinically unsaturated compound.

13. A copolymer powder prepared from an aqueous copolymer dispersion as claimed in either of claims 11 and 12.

14. The use of an aqueous copolymer dispersion as claimed in either of claims 11 and 12 as a binder in adhesives, sealing compounds, plastics renders and coating materials.

15. The use of a copolymer powder as claimed in claim 13 as a binder in adhesives, sealing compounds, plastics renders and coating materials and for the modification of mineral binders or other plastics.
